(19) United States
(12) Patent Application Publication
(10) Pub. No.: US 2010/0007055 A1
(43) Pub. Date: Jan. 14, 2010

(54) METHOD FOR MANUFACTURING CYLINDERS FOR CARTRIDGE CASES AND COMPOSITION

(75) Inventor: Rene GILLOUIN, Bourg Les Valence (FR)

Correspondence Address: CANTOR COLBURN, LLP, 20 Church Street, 22nd Floor, Hartford, CT, 06103, US

(73) Assignee: CHEDDITE FRANCE, Bourg Les Valence (FR)

(21) Appl. No.: 12/350,980

(22) Filed: Jan. 9, 2009

(30) Foreign Application Priority Data
Jan. 9, 2008 (FR) 08/00113

(51) Int. Cl. B29C 43/02; C09D 101/00

(52) U.S. Cl. 264/319; 106/38.51

(57) ABSTRACT

The invention relates to a method for manufacturing cylinders (1) for cartridge cases, carried out in a rotary press machine, wherein a composition (2) of essentially plant origin is made available in a precise volume and weight, the cavities (3) of cylindrical molds (4) adapted to said cylinders (1) are fed with said composition (2), for each cylinder, said composition (2) is compressed in the cavity (3) between on the one hand, two, lower and coaxial, cylindrical dies namely a peripheral die (5), capable of sliding axially in the mold (4) and a central die (6) capable of sliding axially independently in the die (5) and on the other hand, an upper die (7), the distance between the dies (5) and (7) defining the height of the cylinder, and the cylinders obtained are ejected.

### FIELD OF THE INVENTION

The invention relates to cylinders or cartridge cases and more particularly their manufacture.

### BACKGROUND OF THE INVENTION

The cylinders are conventionally based on plastics, whether exclusively of plastics or mainly of plastics with an addition of a mineral filler.

They may be obtained by injecting a molten PE-HD polymer into a multi-cavity mould. According to another manufacturing technique, a thick plastic tube is prepared by extrusion and cylinders are then cut off from the length of the tube.

The quantities of cylinders to be produced are very large and may reach 7 to 8 million parts a day, and the development of manufacturing processes enabling production rates to be increased remains a priority for industrialists. In this search for a more efficient method, the first obstacle encountered is that of choosing the material making up the cylinders. Taking into account the production volumes, this material should not be too costly and should be available in large quantities.

It is within this context that the Applicant has developed a method for manufacturing cylinders from a composition of essentially plant origin, which meets all the requirements for such an application, and overcomes the problems referred to above.

The Applicant has in point of fact discovered that this method may be employed in a rotary press machine.

### BACKGROUND OF THE INVENTION

Thus, one object of the invention is a method for manufacturing cylinders, carried out in a rotary press machine, according to the following steps:
a composition of essentially plant origin is made available,
cavities of cylindrical molds adapted to said cylinders are fed with said composition,
for each cylinder, said composition is compressed in the cavity between on the one hand, two, lower and coaxial, cylindrical dies namely a peripheral die, capable of sliding axially in the mold and a central die capable of sliding axially independently in the die and on the other hand, an upper die, the final distance between the dies defining the height of the cylinder, and
the cylinders obtained are ejected.

The method of the invention makes it possible to employ an abundant raw material of natural origin that is biodegradable and to obtain cylinders having complete homogeneity. They additionally possess a certain degree of malleability that enables them to be suitably deformed when they are finally shaped in the machine for assembling cases.

A substantially plant composition is understood to mean a composition of which at least 90% by weight consists of plant materials. Advantageously, the composition is completely of plant origin. Thus, the composition may comprise an intimate mixture of cellulose fibers and wood fibers or sawdust. The proportion of cellulose fibers preferably varies from 20 to 50% by weight based on the weight of the composition and the proportion of wood fibers or sawdust preferably varies from 80 to 50% by weight based on the weight of the composition.

Such a composition may for example be free from binder. In this case, it may consist only of the aforementioned mixture. When it contains a binder, this is advantageously of plant origin, such as microcrystalline cellulose, starches, or polyethylene glycols.

According to this variant, the proportion of microcrystalline cellulose preferably varies from 2 to 10%, or better still 2 to 5% based on the weight of the composition.

A particularly efficient composition according to the invention comprises 45 to 50% of cellulose fibers, 50 to 53% by weight of wood fibers or sawdust and 2 to 10%, preferably 2 to 5% by weight of microcrystalline cellulose.

A composition as described above, comprising an intimate mixture of cellulose fibers in a proportion varying from 20 to 50% by weight based on the weight of the composition, and wood fibers or sawdust, in a proportion varying from 80 to 50% by weight based on the weight of the composition, is one object of the present invention. It may additionally meet all the aforementioned characteristics.

The use of a composition of substantially plant origin, such as a composition as previously described, in order to obtain cylinders for cartridge cases, is another object of the invention, in particular when the cylinders are manufactured in a rotary press machine.

The Applicant has in addition observed that the combined use of a rotary press machine and a composition such as previously defined makes it possible to obtain cylinders possessing a certain degree of malleability. This property is particularly opportune for obtaining a cartridge from such a cylinder. In point of fact, the cylinder is introduced into the tube of the cartridge and mounted on the case by force, and on account of this fashioning property, a case of excellent quality is obtained.

### BRIEF DESCRIPTION OF THE DRAWINGS

FIG. 1—view of the rotary press machine where the inventive method proceeds.

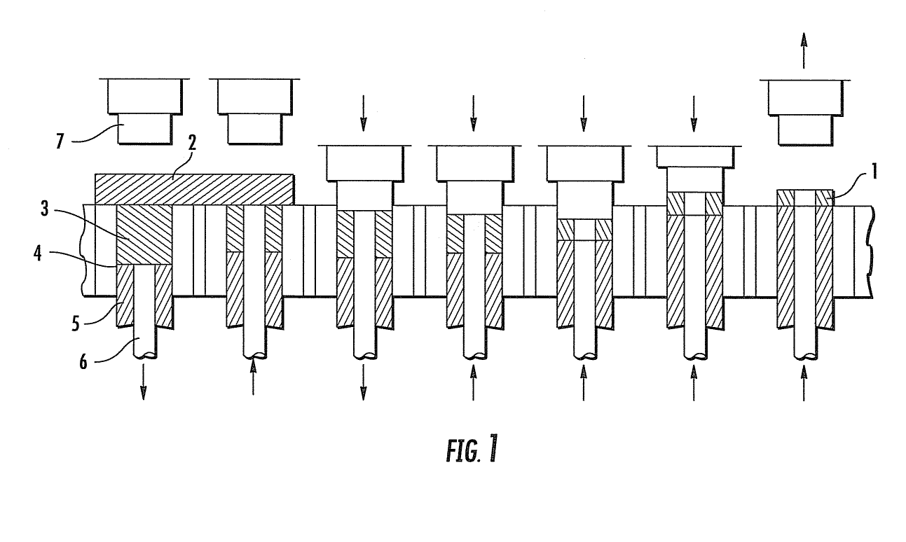

### DETAILED DESCRIPTION OF THE PREFERRED EMBODIMENTS

The invention is now described in greater detail supported by the single appended FIGURE representing part of the rotary press machine where the steps of the method of the invention proceed.

The method comprises the following steps:
A precise volume and weight of a composition 2, of substantially plant origin is made available,
said composition 2 is fed into the cavities 3 of cylindrical molds 4 adapted to said cylinders 1,
for each cylinder, said composition 2 is compressed in the cavity 3 between, on the one hand, two lower and coaxial cylindrical dies, namely a peripheral die 5, capable of sliding axially in the mold 4 and a central die 6 capable of sliding independently axially in the die 5 and, on the other hand, an upper die 7, the distance between the dies 5 and 7 defining the height of the cylinder and
the cylinders obtained are ejected.

For the step of compressing said composition, the lower dies 5 and 6 are actuated upward, the die 6 being displaced over all the length of the cylinder, and the die 7 being actuated downward until it enters into contact with the die 6. After compression, the central die 6 is actuated downward, the upper die 7 is actuated upward, and the peripheral die 5 is actuated upward to eject the cylinder obtained in this way.

The invention is described hereinafter in greater detail, it being possible to consider the features and objects of the invention below alone or in combination with each other.

### EXAMPLE

The two aforementioned constituents of the composition of the invention are provided separately and are intimately mixed. The mixture obtained in this way is directed to a rotary press machine of which a suitable means of operation is described hereinafter. As an example, it consists of a Courtoy rotary press, such as those of the F and MODUL™ series.

A first step consists of introducing a precise volume and weight of the aforementioned mixture 2 into the hollow constituting the cavity 3 of the single mould 4. This single mold 4 is mounted on a rotating plate that has 30 to 50 cavities, each cavity having a diameter close to the diameter of the part produced 1 and a height proportional to the volume of the powdered material employed.

A slide is located above each matrix, still within the axis of the matrix. A cam system makes it possible to lower or raise this slide, at the end of which an upper compressing die is fixed.

Thus, in a second step, the die 7 enters the matrix and by its descent ensures compression of the mixture 2.

In the lower plane and facing it, other slides are located, having a vertical rise and fall movement. They are provided with lower dies, a peripheral die 5 and a central die 6 enabling the hole of the cylinder to be obtained.

In a third step, the cylinder obtained in this way is disengaged and extracted from the matrix.

The cylinder made in this way is situated in the working plane and is removed from this plane by means of the rotation of the plate, by the presence of “deflectors” placed above this plane and by centrifuging.

Other techniques may of course be employed.

It may thus be possible to provide for compression to be carried out, not in a continuous kinematic system, but in an alternating system.

A large multi-die mould working flat (1 m×1 m for example), provided with an upper compression “die-carrier” plate and a lower “ejector-carrier” plate, could, at a rate of one cycle every approximately 20 seconds, achieve a molding rate (mold with 1000 holes) of the order of 160,000 parts per hour.

Whatever the system used, continuous kinematic or alternating molding, it is necessary to exert the force of 4 to 7 tonnes per unit, during compression of the material.

1. A method for manufacturing cylinders for cartridge cases, carried out in a rotary press machine, comprising the steps of:
making a composition of essentially plant origin available;
feeding cavities of cylindrical molds adapted to said cylinders with said composition;
for each cylinder, compressing said composition in the cavity between on the one hand, two, lower and coaxial, cylindrical dies namely a peripheral die, capable of sliding axially in the mold and a central die capable of sliding axially independently in the peripheral die and on the other hand, an upper die, a distance between the peripheral and upper dies defining a height of the cylinder; and
ejecting the cylinders obtained.

2. The method as claimed in claim 1, wherein in order to compress said composition, the peripheral and central dies are actuated upward, the central die being displaced over all of a length of the cylinder, and the upper die being actuated downward until it enters into contact with the central die.

3. The method as claimed in claim 1, wherein after compression, the central die is actuated downward, the upper die is actuated upward and the peripheral die is actuated upward to eject the cylinder obtained in this way.

4. The method as claimed in any one of claims 1, wherein the composition comprises an intimate mixture of cellulose fibers and a second constituent chosen from the group consisting of wood fibers or sawdust.

5. The method as claimed in claim 4, wherein the proportion of cellulose fibers varies from 20% to 50% by weight based on the weight of the composition, and the proportion of wood fibers or sawdust varies from 80% to 50% by weight based on the weight of the composition.

6. The method as claimed in claim 4, wherein the composition further comprises microcrystalline cellulose.

7. The method as claimed in claim 6, wherein the composition comprises 45% to 50% by weight of cellulose fibers, 50% to 53% by weight of wood fibers or sawdust and 2% to 10% by weight of microcrystalline cellulose.

8. The method as claimed in claim 4, wherein the composition is free from binder.

9. A composition comprising an intimate mixture of cellulose fibers, in a proportion varying from 20% to 50% by weight based on the weight of the composition, and a second constituent chosen from the group consisting of wood fibers or sawdust, in a proportion varying from 80% to 50% by weight based on the weight of the composition.

10. The composition as claimed in claim 9, wherein the composition additionally contains microcrystalline cellulose.

11. The composition as claimed in claim 10, wherein the composition comprises 45% to 50% by weight of cellulose fibers, 50% to 53% by weight of wood fibers or sawdust and 2% to 10% by weight of microcrystalline cellulose.

12. The composition as claimed in claim 9, wherein the composition is free from binder.

13. The composition as claimed in claim 9, wherein the composition only consists of said mixture of cellulose fibers and wood fibers or sawdust.

14. A process for using a composition of substantially plant origin to obtain cylinders for cartridge cases.

15. The process as claimed in claim 14, wherein the cylinders are manufactured in a rotary press machine.

16. The process as claimed in claim 14, wherein the composition comprises an intimate mixture of cellulose fibers, in a proportion varying from 20% to 50% by weight based on the weight of the composition, and a second constituent chosen from the group consisting of wood fibers or sawdust, in a proportion varying from 80% to 50% by weight based on the weight of the composition.
